(19) United States
(12) Patent Application Publication
(10) Pub. No.: US 2008/0233808 A1
(43) Pub. Date: Sep. 25, 2008

(54) Conductor terminal and leaf spring contact therefor

(76) Inventors: Konrad Stromiedel, Wolkramshausen (DE); Thomas Truemper, Breitenbach (DE)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/014,307

(22) Filed: Jan. 15, 2008

(30) Foreign Application Priority Data
Jan. 19, 2007 (DE) 10 2007 003 792.0

(51) Int. Cl. H01R 4/48

(52) U.S. Cl. 439/786

(57) ABSTRACT

A leaf spring contact (1) for an electrical conductor terminal is described which is formed in one piece from one piece of metal sheeting and has at least one end a solder lug (15, 19) formed integrally from the metal sheeting, and a leaf spring blade (10), wherein the solder lug (15, 19) changes into a spring area (2) having a greater width than the width of the solder lug (15, 19) and in the spring area (2), the leaf spring blade (10) of the metal sheeting is exposed in such a manner that the metal sheeting strips adjacent to the leaf spring blade (10) form a support frame for the leaf spring blade (10) which has two longitudinal frame carriers (11) extending spaced apart from one another in parallel with one another, and a frame cross part which is joined in one piece with the blade heel of the leaf spring blade (10), and wherein the leaf spring blade (10) is bent out of the plane of the surface extent of the support frame. The metal sheeting is formed from a spring material alloy and is plated on at least one top side with a conductive metal sheeting of an electrically conductive conductor material with current carrying capacity and the at least one solder lug (15, 19) is tinned.

The invention relates to a leaf spring contact of flat construction for an electrical conductor terminal which is formed in one piece from one piece of metal sheeting and has at least one end a solder lug formed integrally from the metal sheeting, and a leaf spring blade, the solder lug changing into a spring area having a greater width than the width of the solder lug and in the spring area, the leaf spring blade of the metal sheeting being exposed in such a manner that the metal sheeting strips adjacent to the leaf spring blade form a support frame for the leaf spring blade which has two frame side parts extending in parallel with the longitudinal extent of the leaf spring blade and a frame cross part which is joined in one piece to the blade heel of the leaf spring blade, and wherein the leaf spring blade is bent out of the plane of the surface extent of the support frame.

The invention also relates to a conductor terminal with a housing of insulating material and at least one leaf spring contact, described above, built into the housing of insulating material in such a manner that the leaf spring blade protrudes into an associated conductor entry hole formed in the housing of insulating material.

Conductor terminals and leaf spring contacts therefor are available in very many constructional forms. The leaf spring contacts are preferably manufactured in one piece. The present invention deals with the constructional form of a leaf spring contact in which a leaf spring blade is lifted from a piece of metal sheeting, for example, by cutting free or punching free in such a manner that the metal sheeting strips adjacent to the leaf spring blade form a support frame for the leaf spring blade. The support frame comprises two spaced-apart frame side parts extending in parallel with one another and a frame cross part which is arranged in one piece with the blade heel of the leaf spring blade. The leaf spring blade is bent out of the plane of the surface extent of the support frame. The metal sheeting used has elastic spring characteristics.

Leaf spring contacts of the aforementioned type are used for conductor terminals as are represented, e.g. in AT 402 768 B and DE 203 03 537 U1. These conductor terminals in each case have current rails held fixed (e.g. of a rigid copper material) against which the electrical conductor to be connected in each case is electrically and mechanically clamped by means of a leaf spring blade which, for this purpose, is moved in from its respective metal sheeting support frame when the electrical conductor is moved into the clamping position as a result of which a restoring force is built up in the leaf spring blade which is used for clamping the electrical conductor against the respective current rail.

From DE 10 2004 030 085 A1, for example, it is also known to use a piece of spring steel plate as carrier plate for a current rail piece and to connect this carrier plate with the spring steel plate from which the leaf spring blade has been cut free, in such a manner that the two spring steel plates proportionally elastically resiliently carry out the required opening lift of the clamping position when connecting an electrical conductor.

Apart from the aforementioned constructional forms of leaf spring contacts, there are also those in which the restoring force of the leaf spring blade is not generated by the leaf spring blade being moved away from its support frame when an electrical conductor is inserted into the respective conductor clamping position, but the reverse case is implemented in which the leaf spring blade is moved towards its support frame when an electrical conductor is inserted into the respective conductor clamping position. This constructional form is possible only when, in the production process, the leaf spring blade is bent out of the plane of the surface extent of the support frame with an angle of attack in the area of its blade heel in such a manner that during this bending process, the material of the blade heel arc is strain hardened and thus strain hardened in the bent-out state of the leaf spring blade. U.S. Pat. No. 4,673,232 shows such a leaf spring contact.

FR 1 049 581 A discloses a leaf spring contact folded in one piece from an elastic bronze material. A blade is bent out of the folded metal sheeting. Due to the material which has current carrying capacity but is not resilient, it does not have any spring characteristics required for a conductor terminal.

On the basis of this, it is the object of the present invention to create an improved leaf spring contact for an electrical conductor terminal which is of one piece and of flat construction and, apart from high spring forces, also has an adequate current carrying capacity and good solderability for further processing.

The object is achieved by means of the leaf spring contact of the type initially mentioned, due to the fact that the metal sheeting is formed from a spring material alloy and is plated on at least one top side with a conductive metal sheeting of an electrically conductive conductor material with current carrying capacity and the at least one solder lug is tinned.

It is thus proposed to create a one-piece leaf spring contact due to the fact that the metal sheeting consists in its core of a spring material alloy which, to improve its current carrying capacity, is coated with a conductor material which is more conductive than the spring material alloy. The leaf spring blade is then lifted out of this multi-layered metal sheeting. At the at least one end of the leaf spring contact, the spring material alloy plated with conductor material is additionally tinned in order to create good solderability of the solder lug formed at the ends.

The spring material sheet plated with conductive metal sheeting makes it possible to provide sufficiently high spring forces of the leaf spring blade due to the spring material alloy and to compensate for the conductivity and current carrying capacity of the available spring material alloys, which is not adequate for conductor terminals, by means of the conductive metal sheeting. The plating of the spring material sheet with the conductive metal sheeting does not significantly impair the spring characteristics. The plated metal sheeting can also be tinned so that the solder lugs can be soldered without problems for example in a reflow process.

The ratio of conductivity of the spring material alloy to the conductivity should be less than 1/10 and preferably less than 1/50 and particularly preferably less than 1/70.

The spring material alloy is preferably a chromium nickel alloy as is normally used for the contact springs of conductor terminal contacts. The conductor material can be copper or bronze or a similar material of good conductivity or can be formed of an alloy containing such metals of good conductivity.

The leaf spring contact is preferably bent L- or U-shaped in such a manner that the spring area with the support frame extends transversely to the solder lug. If only one solder lug is provided at one end of the metal sheeting, the leaf spring contact is preferably bent L-shaped. In the case of solder lugs at both ends of the metal sheeting, these solder lugs are preferably bent away in the same direction from the spring area and extend in parallel with one another. The leaf spring contact is then arranged to be U-shaped.

In the case of a leaf spring contact according to U.S. Pat. No. 4,673,232, the spring force of the leaf spring blade, which is bent out of a piece of metal sheeting with strain hardening of its blade heel arc, can be improved in such a manner that the leaf spring contact overall is still of flat construction but is distinguished by significantly higher spring forces of the leaf spring blade. This becomes possible due to the fact that the frame side parts are in each case formed in the manner of a longitudinal carrier which rests on end-supports, namely with one support in the area of the blade heel arc and with one support in the area of the other end of the longitudinal frame carrier.

In contrast to the previous prior art in which the support frame of the metal sheeting, out of which the leaf spring blade is bent out, in most cases rests flatly at a housing wall of the housing of insulating material of the conductor terminal (and thus, unused, only fixes the position of the leaf spring blade), the preferred embodiment shows that the frame side parts of the support frame, in the manner of a supporting framework (i.e. in the manner of a bearer on two posts) can be subjected to a bending strain in dependence on the bending load of the leaf spring blade as a result of which the spring forces of the leaf spring blade (and thus the spring clamping force of the conductor terminal) are very significantly increased.

This improvement in the clamping force of the leaf spring blade is achieved without the leaf spring contact requiring a significantly larger constructional form. It is only necessary to provide a small installation height for the bilateral supports of the longitudinal carriers of the support frame which are suitably structurally to be built into the housing of insulating material of a conductor terminal in such a manner that the longitudinal frame carriers are free of loads resting on them and free of bending limitations between their supports so that the longitudinal carriers can bend through freely and only in dependence on the bending load of the leaf spring blade.

A further advantageous embodiment provides that the longitudinal frame carriers are constructed in the form of a longitudinal carrier straight and level in the load-free state between their supports as, in the normal case, corresponds to the original shape of the metal sheeting from which the leaf spring blades are lifted, for example cut free or punched free.

Both supports of the longitudinal carriers of the support frame can be supports of insulating material which are molded from material of the housing of insulating material of the conductor terminal. A suitable and functionally optimal constructional form provides, however, that the support arranged in the area of the blade heel arc of the leaf spring blade is formed by an approximately 90° shaped arc of the end piece of the longitudinal frame carrier, wherein such a shaped arc can preferably be a 91° circular arc.

In conjunction with such a 90° shaped arc, it is advantageous if the blade heel arc of the leaf spring blade corresponds to the shaped arc of the support at the heel end of the longitudinal frame carrier and is joined in one piece to the shaped support arc of the longitudinal frame carrier over about ⅔ of its arc length. Tests by the applicant have shown that such a ⅔ joint converts the bending load of the leaf spring blade in the best possible manner into a corresponding bending load of the longitudinal frame carriers and couples the bending lines (equal to bending strains) of both components with one another.

With regard to the structural situation of installing the leaf spring contact into an electrical conductor terminal, it is appropriate if a support of the longitudinal frame carrier is constructed as fixed bearing and the other support of the longitudinal frame carrier is constructed as movable bearing.

In the constructional form of the leaf spring contact in which the bending strain is utilized, a clamping or screw connection or a rigid connection to another leaf spring contact can also be provided instead of the tinned solder lug.

The metal sheeting used for the leaf spring contact has good elastic resilience characteristics and has adequate electrical conductivities for the case where the leaf spring contact directly clamps the electrical conductor to be connected against insulating material of the housing of insulating material of the conductor terminal which is quite normal with relatively low ampere currents. For this purpose, the leaf spring contact is built from a spring steel plate which is coppered and tinned, or of a bronze material, or of e.g. of a basic copper material with improved resiliency characteristics.

It is also possible to construct the leaf spring contact undivided, i.e. in one piece with an extension leg which, starting from one or the other end of the longitudinal frame carrier or carriers is deformed and bent towards the conductor clamping point in such a manner that it offers a thrust bearing for the conductor clamping point. In such a case, the electrical conductor is electrically and mechanically clamped between the leaf spring blade and the thrust bearing as a result of which a “self supporting” leaf spring contact is formed which does not transfer any clamping force to the insulating material of the housing of insulating material of the conductor terminal.

The leaf spring contact described above is preferably installed in a housing of insulating material of a conductor terminal in such a manner that the leaf spring blade protrudes into an associated conductor entry hole formed in the housing of insulating material. When a stripped end of an electrical conductor is introduced into the conductor entry hole, the leaf spring blade is deflected by the electrical conductor and presses the electrical conductor against the housing of insulating material in order to produce in this manner an electrical contact of the electrical conductor with the leaf spring contact.

To avoid excessive deflection of the leaf spring blade and thus overloading it, on the side of the housing of insulating material opposite the inlet into the conductor entry hole, an overload protection web formed integrally with the housing of insulating material, which protrudes into the spring area and is arranged between the support frame and the leaf spring blade in such a manner that the end of the leaf spring blade rests on the overload protection web with a maximum permissible deflection of the leaf spring blade in the direction of the support frame, defined by the overload protection web, is provided in a preferred embodiment.

This at least one overload protection web is constructed, for example, on a rear sealing cap molded swivelably on the housing of insulating material by means of a film hinge. During the assembly of the conductor terminal, the leaf spring contacts can thus be inserted into the housing of insulating material from its rear accessible through the opened rear sealing cap. Following this, the rear sealing cap is shut and latched, wherein the overload protection webs molded on the inside of the rear sealing cap protrude into the interior space of the housing of insulating material in such a manner that the overload protection webs rest between the leaf spring contacts and the support frame of the leaf spring contacts.

However, it is also conceivable that the housing of insulating material does not have any openable assembly openings but is constructed closed in one piece. In such an embodiment, the at least one overload protection web can again be molded on the inside of the rear wall of the housing of insulating material which is constructed closed in one piece and can protrude into the conductor entry hole. Underneath a conductor entry hole in each case an associated guide channel for accommodating and guiding a leaf spring contact is then introduced which has a stop which is positioned in such a manner that the leaf spring blade, during the assembly of the leaf spring contact inserted into the guide channel can be swiveled past the overload protection web into the conductor entry hole and with a subsequent shifting of the leaf spring contact away from the stop, the end of the leaf spring blade rests on the overload protection web in the case of deflection of the leaf spring blade. The leaf spring blade is thus pulled through underneath the overload protection web during the assembly and during this process is deflected for a short time more than is permitted by the overload protection web in the assembled state. After the leaf spring blade has been guided past the overload protection web and has snapped into the conductor entry hole, the leaf spring blade is pushed back again a little so that the overload protection web can become effective.

If underneath a conductor entry hole in each case an associated guide channel for accommodating a leaf spring contact is provided in the housing of insulating material as, for example, in the embodiment described, the at least one leaf spring contact can be wedged in the guide channel by deformation of the housing of insulating material. This fixes the leaf spring contact relative to the housing of insulating material.

If the rear sealing cap with a film hinge is molded on the housing of insulating material, the problem occurs during the assembly that the lower edge of the rear sealing cap must be placed to fit the bottom of the housing of insulating material. Due to the flexibility of the film hinge, it may happen that the lower edge of the rear sealing cap protrudes too far downward. To prevent this and provide for unproblematic fast automatic or manual production, at least one bending post pointing in the direction of the film hinge is molded on at the rear of the housing of the insulating material adjoining the film hinge. The bending post is constructed in such a manner that when the rear sealing cap is closed, an unfavorable deflection of the film hinge is prevented and, as a result, the lower edge of the rear sealing cap is guided to fit into the latching position with the bottom of the housing of insulating material.

In the text which follows, the invention will be described in greater detail by means of illustrative embodiments, with reference to the attached drawings, in which:

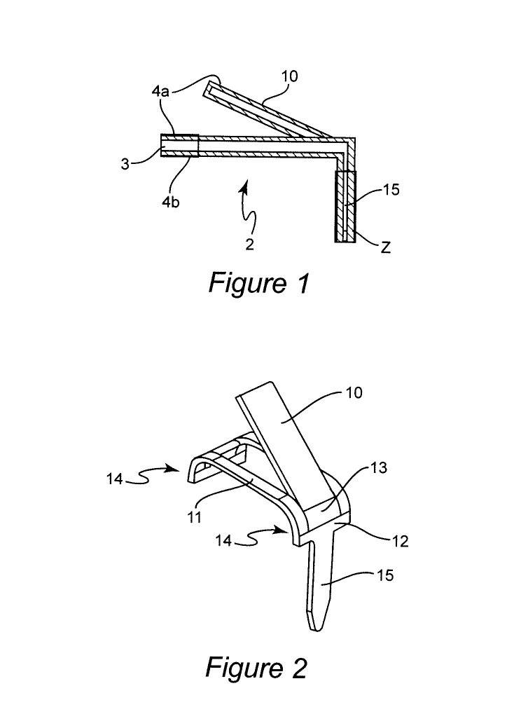

FIG. 1 shows a simplified embodiment of a leaf spring contact with tinned solder lug and copper-plated chromium nickel spring steel;

FIG. 2 shows a perspective view of a second embodiment of a leaf spring contact;

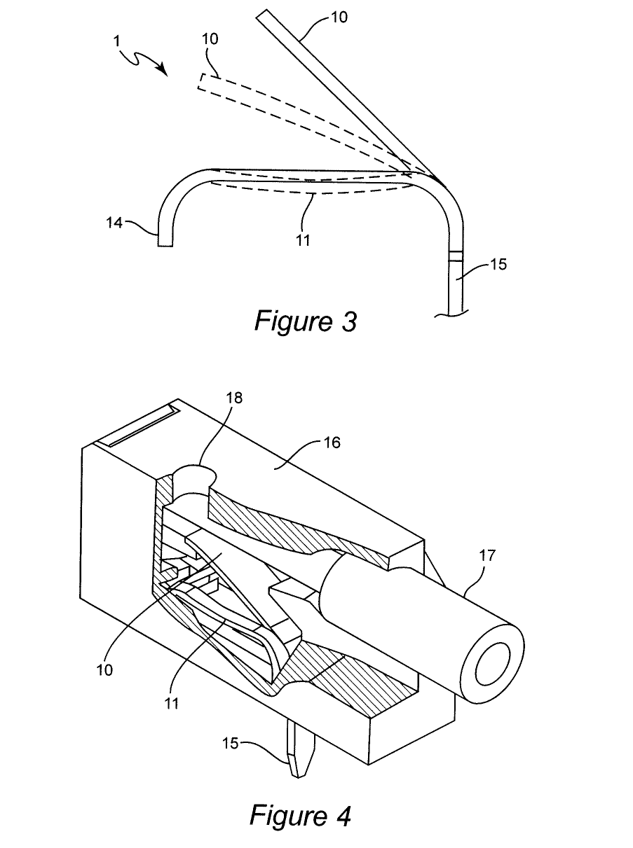

FIG. 3 shows a side view of the leaf spring contact from FIG. 1;

FIG. 4 shows a perspective part-section view of a housing of insulating material with leaf spring contact built into it and inserted conductor;

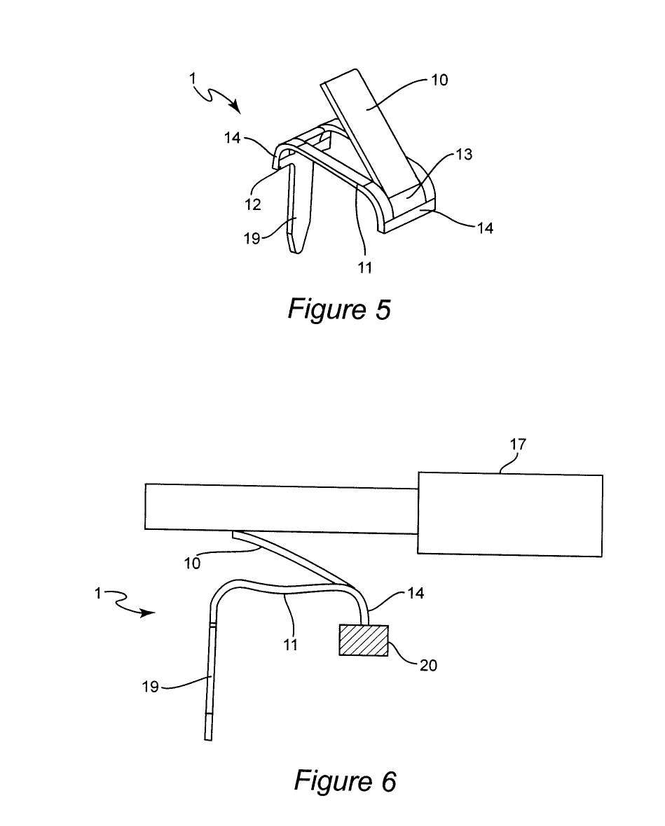

FIG. 5 shows a perspective representation of a third embodiment of a leaf spring contact;

FIG. 6 shows a side view of the leaf spring contact from FIG. 5 with conductor end lying above it;

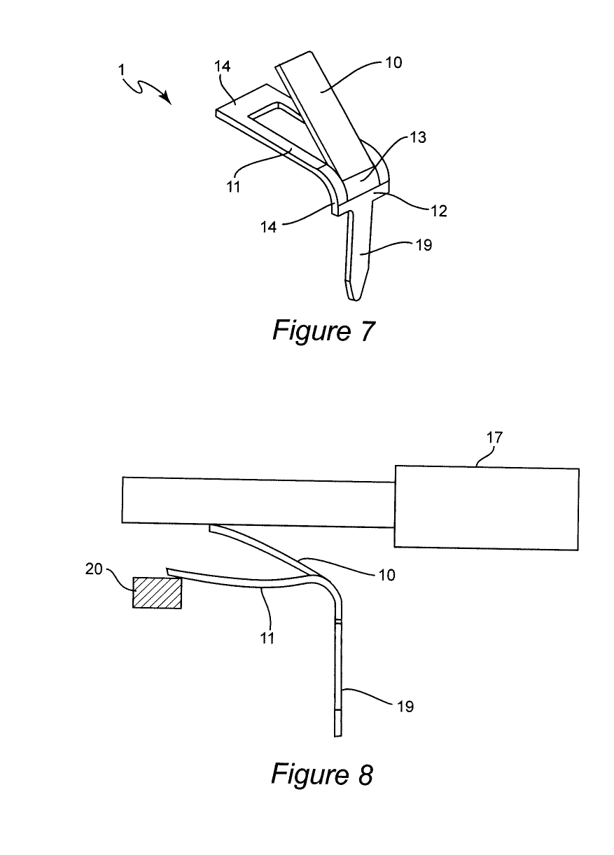

FIG. 7 shows a perspective representation of a fourth embodiment of a leaf spring contact;

FIG. 8 shows a side view of the leaf spring contact from FIG. 7 with conductor arranged above it;

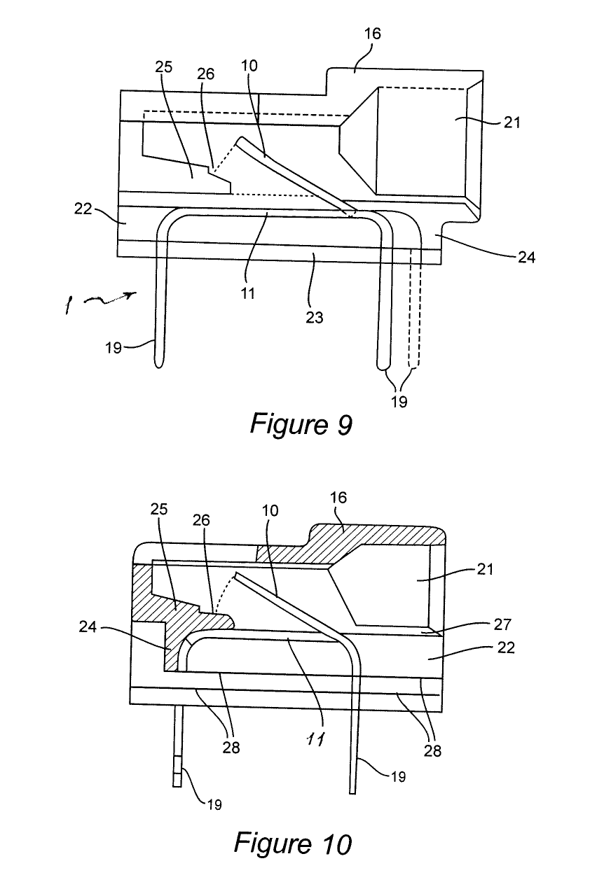

FIG. 9 shows a side section view of a housing of insulating material constructed closed on one side with leaf spring contact which can be inserted from the rear;

FIG. 10 shows a side section view of a housing of insulating material closed in one piece with leaf spring contact which can be inserted from the front;

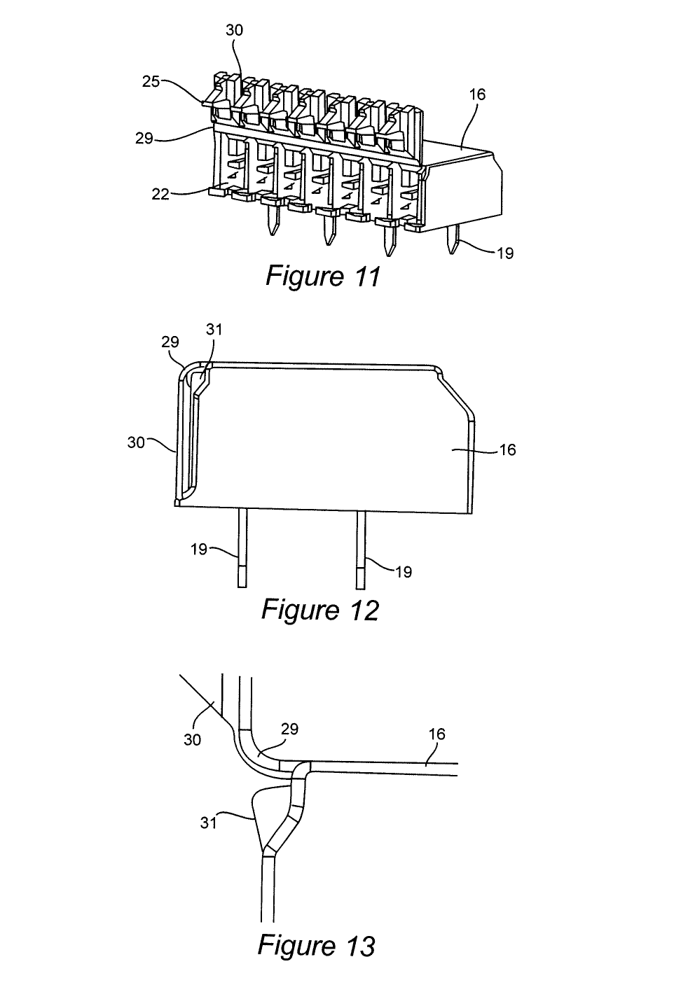

FIG. 11 shows a perspective view of a conductor terminal from the rear with opened rear sealing cap;

FIG. 12 shows a side view of the conductor terminal from FIG. 11 with closed rear sealing cap;

FIG. 13 shows a sectional view of the conductor terminal from FIGS. 11 and 12 with open rear sealing cap in the area of the film hinge.

FIG. 1 shows a leaf spring contact 1 in which a leaf spring blade 10 is exposed and bent out of a one-piece metal sheeting. The remaining metal sheeting forms a support frame with longitudinal carriers 11 in the spring area 2. A solder lug 15 projects at an angle from the spring area 2, for example at right angles.

The metal sheeting is formed from a spring material alloy, for example from a chromium nickel spring steel, in the core layer 3. The core layer 3 is plated on one side and preferably on both sides with a conductor material 4a, 4b which is electrically conductive and has current carrying capacity. The conductor material 4a, 4b, for example of copper or bronze or a copper- and bronze-containing alloy ensures the low electrical resistance necessary for the electrical connection of an electrical conductor, and thus adequate current carrying capacity.

The solder lug 15 is tinned (layer 7), so that it can be easily soldered.

Due to the spring material plated with conductive metal sheeting, it is possible to provide both the spring characteristics for the leaf spring blade 10, which are required for a one-piece leaf spring contact 1, and the necessary electrical characteristics, particularly a low resistance and high current carrying capacity without additional current rails or special structural shaping being required.

Since the leaf spring contact is bent over, the direction of extent of the plated-on conductive metal sheeting should extend in the direction of extent of the leaf spring blade 10.

FIG. 2 shows a perspective view of a special embodiment of the leaf spring contact 1 which is formed from a piece of metal sheeting in such a manner that the leaf spring blade 10 is cut free from the metal sheeting, retaining the metal sheeting strips adjacent to the leaf spring blade 10 and using them as longitudinal carriers 11 for a support frame, the frame cross part 12 of which is arranged of one piece with the blade heel 13 of the leaf spring blade 10.

The longitudinal frame carriers 11 are in each case carried by two supports 14 at the ends (in the manner of a bearer on two posts), wherein, in the illustrative embodiment shown in FIG. 2, the supports 14 are formed by the respective 90° shaped arcs of the end pieces of the longitudinal frame carrier 11.

It can be seen that the blade heel arc 13 of the leaf spring blade 10 corresponds to the shaped arc of the supports 14 at the heel end and is joined in one piece over about ⅔ of its arc lengths to the respective shaped support arc of the longitudinal frame bearings 11 existing on both sides. As a result, the respective deflections of the leaf spring blade 10 and of the longitudinal frame carriers 11 are coupled to one another.

FIG. 3 shows the respective bending lines (equal to bending strains) of the leaf spring blade 10 and the longitudinal frame carriers 11 in the unloaded state (corresponding to the continuous lines) and in the loaded state (corresponding to the dashed lines).

FIG. 4 shows the installed state of the leaf spring contact 1 with its longitudinal frame carriers 11 and the leaf spring blade 10 in the housing of insulating material 16 of a conductor terminal for printed circuits. For soldering into the circuit, a solder lug 15 is molded onto the right-hand end of the leaf spring contact 1 shown in FIGS. 1 and 2. The right-hand end is a so-called fixed bearing in the present illustrative embodiment. The conductor terminal with an electrical conductor 17 inserted and clamped against the insulating material of the housing of insulating material 16 can also be seen. The housing of insulating material 16 has a test opening 18 in the normal manner.

FIG. 5 shows a third illustrative embodiment of the leaf spring contact 1 corresponding to the second illustrative embodiment according to FIGS. 2 and 3, but with a solder lug 19 which, in the present illustrative embodiment, is molded onto the end of the longitudinal frame carriers 11 shown on the left-hand side. The left-hand end with the solder lug 19 is again the fixed bearing.

This becomes clearer in FIG. 6 which shows a side view of the third embodiment of the leaf spring contact 1 with an electrical conductor 17 resting on the end of the leaf spring blade 10. The right-hand support 14 of the longitudinal frame carrier 11 is constructed as so-called movable bearing in conjunction with a plastic support 20 of the housing of insulating material 16.

FIGS. 7 and 8 show a fourth embodiment of the leaf spring contact 1 in which the support, shown on the left-hand side, of the longitudinal frame carriers 11 is constructed as so-called movable bearing, formed by a plastic support 20 of the housing of insulating material 16. The advantages of a leaf spring contact 1 built in accordance with the teachings of the invention also exist with such a support arrangement of the longitudinal frame carriers 11 of the leaf spring contact 1.

FIG. 9 shows a side section view of a special embodiment of a conductor terminal in which the housing of insulating material 16 is constructed in one piece without assembly flaps for installing the leaf spring contact 1. Below the conductor entry hole 21 opened at the front of the housing of insulating material 16, a guide channel 22 is provided which is matched to the leaf spring contact 1 in such a manner that it is held in the guide channel 22 and the solder lugs 19 protrude out of the bottom 23 of the housing of insulating material 16, which limits the guide channel 22, and the leaf spring contact 1 is held in the guide channel 22 in this arrangement. To assemble the conductor terminal, the leaf spring contact 1 is pushed from the rear into the guide channel 22, the leaf spring blade 10 being strongly deflected. When the leaf spring contact 1 reaches a stop 24 provided in the front area of the guide channel 22, the leaf spring blade 10 no longer abuts against an overload protection web 25 protruding into the conductor entry hole 21 from the rear and bounces upward into the conductor entry hole 21. To prevent an excessive deflection of the leaf spring blade 10, the leaf spring contact 1 is again displaced away from the stop (from the dashed position) to such an extent that during a deflection of the leaf spring blade 10, the end of the leaf spring blade 10 rests on the overload protection web 25, preferably in a trough 26 produced in it. The leaf spring contact 1 can subsequently be wedged, i.e. fixed at the housing of insulating material 16, by deformation of the housing of insulating material 16.

FIG. 10 shows a different embodiment of a conductor terminal in which the guide channel 22 is accessible from the front of the housing of insulating material 16. The stop 24 is formed at the rear below the overload protection web 25. When the leaf spring 1 is inserted into the housing of insulating material 16, the leaf spring blade 10 is first deflected to such an extent that it is moved past below the lower wall 27 of the conductor entry hole 21 until it can bounce into the conductor entry hole 21 due to a cut in the material applied in the housing of insulating material 16 at this point. The leaf spring 1 is then displaced up to the stop 24 and possibly wedged with the housing of insulating material 16 and during this process fixed at the housing of insulating material 16 by remolded material projections 28.

FIG. 11 shows a further variant of a conductor terminal in which the rear of the housing of insulating material 16 can be closed with the aid of a rear sealing cap 30 pivoted at the housing of insulating material 16 by means of a film hinge 29. During the assembly, the leaf spring contacts 1 can be pushed into the guide channel 22 from the rear and can be held in the housing of insulating material 16 by the rear sealing cap 30 which is then folded down and latched to the bottom of the housing of insulating material 16. On the inside of the rear sealing cap 30, an overload protection web 25 is in each case molded on for a leaf spring contact 1, which, after the rear sealing cap 30 is closed, lies between the longitudinal frame bearing 11 of the leaf spring contact 1 and the leaf spring blade 10 in the manner shown in FIGS. 9 and 10.

FIG. 12 shows a side view of the closed conductor terminal from FIG. 11. When the rear sealing cap 30 is closed, it must be ensured that the lower edge of the rear sealing cap 30 is correctly aligned to the rear edge of the bottom of the housing of insulating material 16 in the closing position and does not protrude too far to the bottom due to an unfavorable bulging of the film hinge 29. At the rear of the housing of insulating material 16, at least one bending post 31, preferably one bending post 31 per leaf spring contact 1, is provided, therefore, which is arranged adjacently to the film hinge 29 and points towards the film hinge 29 in such a manner that during an unfavorable deflection of the film hinge 29, it abuts against the bending post 31 and is deflected in such a manner that it is ensured that the lower edge of the rear sealing cap 30 is guided to fit into the closing position.

1. A leaf spring contact (1) for an electrical conductor terminal which is formed in one piece from one piece of metal sheeting and has at at least one end a solder lug (15) formed integrally from the metal sheeting, and a leaf spring blade (10), wherein the solder lug (15) changes into a spring area (2) having a greater width than the width of the solder lug (15) and in the spring area (2), the leaf spring blade (10) of the metal sheeting is exposed in such a manner that the metal sheeting strips adjacent to the leaf spring blade (10) form a support frame for the leaf spring blade (10) which has two frame side parts extending in parallel with the longitudinal extent of the leaf spring blade (10) and a frame cross part which is joined in one piece to the blade heel of the leaf spring blade (10), and wherein the leaf spring blade (10) is bent out of the plane of the surface extent of the support frame, wherein the metal sheeting is formed from a spring material alloy and is plated on at least one top side with a conductive metal sheeting of an electrically conductive conductor material with current carrying capacity and the at least one solder lug (15) is tinned.

2. The leaf spring contact (1) as claimed in claim 1, wherein the spring material alloy is a chromium nickel alloy.

3. The leaf spring contact (1) as claimed in claim 1, wherein the conductor material is copper or bronze or is formed from an alloy containing copper and/or bronze.

4. The leaf spring contact (1) as claimed in claim 1, wherein the spring area (2) with the support frame extends transversely to the solder lug (15).

5. The leaf spring contact (1) as claimed in claim 1, wherein the leaf spring blade (10), from the point of view of production, is bent out of the plane of the surface extent of the support frame with a shallow angle of attack in the area of its blade heel as a result of which the material of the blade heel arc is strain hardened in the bent-out state, and the frame side parts are in each case formed in the manner of a longitudinal carrier (11) which rests on two end-supports (14), namely with one support in the area of the blade heel arc (13) and with one support in the area of the other end of the longitudinal frame carrier.

6. The leaf spring contact (1) as claimed in claim 5, wherein the longitudinal frame carriers are free of loads resting on them and free of bending limitations between their supports.

7. The leaf spring contact (1) as claimed in claim 5, wherein the longitudinal frame carriers are constructed in the form of a longitudinal carrier which is straight and level in the load-free state between their supports.

8. The leaf spring contact (1) as claimed in claim 5, wherein the support at the heel end is formed by an approximately 90° shaped arc of the end piece of the longitudinal frame carrier.

9. The leaf spring contact (1) as claimed in claim 8, wherein the blade heel arc (13) of the leaf spring blade corresponds to the shaped arc of the support (14) at the heel end of the longitudinal frame carrier and is joined in one piece to the shaped support arc of the longitudinal frame carrier over about ⅔of its arc length.

10. The leaf spring contact (1) as claimed in claim 1, wherein the support (14) is formed by a plastic support (20) of the housing of insulating material of the conductor terminal at the end of the longitudinal frame carrier which is not at the heel end.

11. The leaf spring contact (1) as claimed claim 1, wherein a support (14) of the longitudinal frame carrier is constructed as fixed bearing and the other support (14) of the longitudinal frame carrier (11) is constructed as movable bearing and the end of the longitudinal frame carrier (11) associated with the fixed bearing has a solder, clamping or screw connection.

12. A conductor terminal with a housing of insulating material (16) and at least one leaf spring contact (1) for an electrical conductor terminal which is formed in one piece from one piece of metal sheeting and has at at least one end a solder lug (15) formed integrally from the metal sheeting, and a leaf spring blade (10), wherein the solder lug (15) changes into a spring area (2) having a greater width than the width of the solder lug (15) and in the spring area (2), the leaf spring blade (10) of the metal sheeting is exposed in such a manner that the metal sheeting strips adjacent to the leaf spring blade (10) form a support frame for the leaf spring blade (10) which has two frame side parts extending in parallel with the longitudinal extent of the leaf spring blade (10) and a frame cross part which is joined in one piece to the blade heel of the leaf spring blade (10), and wherein the leaf spring blade (10) is bent out of the plane of the surface extent of the support frame, wherein the metal sheeting is formed from a spring material alloy and is plated on at least one top side with a conductive metal sheeting of an electrically conductive conductor material with current carrying capacity and the at least one solder lug (15) is tinned, built into the housing of insulating material (16) in such a manner that the leaf spring blade (10) protrudes into an associated conductor entry hole (21) formed in the housing of insulating material (16).

13. The conductor terminal as claimed in claim 12, wherein, on the side of the housing of insulating material (16) opposite the inlet into the conductor entry hole (21), an overload protection web (25), formed integrally with the housing of insulating material (16), protrudes into the spring area (2) and is arranged between the support frame and the leaf spring blade (10) in such a manner that the end of the leaf spring blade (10) rests on the overload protection web (25) with a maximum permissible deflection of the leaf spring blade (10) in the direction of the support frame, defined by the overload protection web (25).

14. The conductor terminal as claimed in claim 12, wherein the at least one overload protection web (25) is formed on a rear sealing cap (30) molded swivelably on the housing of insulating material (16) by means of a film hinge (29).

15. The conductor terminal as claimed in claim 14, wherein on the rear wall adjacently to the film hinge (29), at least one bending post (31) pointing in the direction of the film hinge (29) is molded on in such a manner that when the rear sealing cap (30) is closed, the at least one bending post (31) prevents a bending movement of the film hinge (29) during which the lower edge of the rear sealing cap (30) opposite the film hinge (29) abuts against the rear edge of the bottom of the housing of insulating material (16).

16. The conductor terminal as claimed in claim 12, wherein the at least one overload protection web (25) is molded on the inside of the rear wall of the housing of insulating material (16) which is constructed closed in one piece and protrudes into the conductor entry hole (21) and underneath a conductor entry hole (21) in each case an associated guide channel (22) for accommodating and guiding a leaf spring contact (1) is introduced which has a stop (24) which is positioned in such a manner that the leaf spring blade (10), during the assembly of the leaf spring contact (1) inserted into the guide channel (22) can be swiveled past the overload protection web (25) into the conductor entry hole (21) and with a subsequent shifting of the leaf spring contact (1) away from the stop, the end of the leaf spring blade (10) rests on the overload protection web (25) in the case of a maximum deflection of the leaf spring blade (10).

17. The conductor terminal as claimed in claim 12, wherein underneath a conductor entry hole (21) in each case an associated guide channel (22) for accommodating a leaf spring contact (1) is provided in the housing of insulating material (16) and the at least one leaf spring contact (1) is wedged in the guide channel (22) by deformation of the housing of insulating material (16).
